(19) United States
(12) Patent Application Publication
(10) Pub. No.: US 2025/0386193 A1
(43) Pub. Date: Dec. 18, 2025

(54) OFFENSE TYPE NETWORK VULNERABILITY SCANNER

(71) Applicant: T-Mobile USA, Inc., Bellevue, WA (US)

(72) Inventors: Geoffrey Todd Gibson, Ben Wheeler, TX (US); Jeffrey Scott Simon, JR., Issaquah, WA (US); Gaurav Madan, Issaquah, WA (US); Shawn David Corey, Kenmore, WA (US); Derek Thomas Ogle, Everett, WA (US)

(21) Appl. No.: 18/743,975

(22) Filed: Jun. 14, 2024

(51) Int. Cl. H04W 12/12; H04W 12/67; H04W 84/04

(52) U.S. Cl. CPC H04W 12/12; H04W 12/67; H04W 84/042

(57) ABSTRACT

Techniques for deploying and using offense-type network vulnerability scanners are disclosed herein. Network vulnerability scanners can be deployed at multiple locations in a network. The network vulnerability scanners can cause equipment with external connections to the network, such as user equipment which is configured for testing purposes, or other device(s) with or without external network connections to perform network vulnerability test operations. The network vulnerability test operations can expose network vulnerability information associated with external connections of the user equipment to the network.

### BACKGROUND

As fifth generation (5G) mobile networks continue to evolve towards hardware disaggregation, cloudification, network slicing, edge computing, etc., the attack surfaces of mobile network operators' networks are growing. Cyber criminals can exploit these larger attack surfaces, resulting in significant damage.

Similarly, other types of networks, such as broadband internet networks including fiber networks, fixed wireless networks, etc., are also changing in ways that present ever larger attack surfaces. For the communications industry, security problems are expected to continue to evolve and widen when subsequent generation networks such as sixth generation (6G) and seventh generation (7G) are introduced.

Mobile and broadband network operators therefore need more proactive approaches for developing cybersecurity offensive type capabilities which allow them to identify security gaps, holes, and other vulnerabilities in their own networks, before threat actors do.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example network architecture including security scanner(s) deployed at user equipment (UEs) and security scanner(s) deployed at mobile switching office (MSO) locations, wherein the security scanner(s) are configured to perform network vulnerability tests, according to an example of the present disclosure.

FIG. 2 illustrates an example scanner and components thereof, according to an example of the present disclosure.

FIG. 3 illustrates example configuration and operation of scanner(s), according to another example of the present disclosure.

FIG. 4 illustrates a variety of example scanners and example network components which can be scanned thereby, according to an example of the present disclosure.

FIG. 5 is a flowchart illustrating example operations performed by a scanner, according to an example of the present disclosure.

FIG. 6 is a flowchart illustrating example operations performed by network equipment configured to deploy and use scanners to determine network vulnerabilities, according to an example of the present disclosure.

FIG. 7 illustrates example network equipment that can implement the techniques disclosed herein, according to an example of the present disclosure.

### DETAILED DESCRIPTION

Techniques for deploying and using an offense-type network vulnerability scanner are disclosed herein. Network vulnerability scanners can be deployed at multiple locations in a network. The network vulnerability scanners can cause equipment with external connections to the network, such as user equipment which is configured for testing purposes, or other device(s) with or without external network connections, to perform network vulnerability test operations. The network vulnerability test operations can expose network vulnerability information associated with external connections to the network.

In a mobile network example, security scanners can be deployed within a subscriber network. The scanners can be configured to perform network vulnerability test operations that target infrastructure and services exposed over traditional macro cell sites, small cell sites, edge computing sites, co-location sites, data centers, mobile switching centers, etc. The scanners can optionally be configured to scan for vulnerabilities of multiple different network technologies that can be included in today's networks, including second generation (2G), third generation (3G), fourth generation (4G), fifth generation (5G) and subsequent generation mobile network technologies, as well as Wi-Fi, Bluetooth, personal area networking, near field communication, and other network technologies. The scanners can perform security vulnerability scanning against a mobile network operator's network infrastructure and services, attempting to find any security gaps, holes, and other vulnerabilities.

Likewise, scanners disclosed herein can be deployed within fixed wireless access type networks, fiber networks, and other broadband networks. Deployed scanners can be configured to scan both wireless and wired infrastructure of a broadband service provider.

In addition to scanning infrastructure, scanners can be configured to search for vulnerabilities in the control plane, user plane, and management planes of a network. Example network technologies that can be scanned according to the techniques disclosed herein include network slicing technologies, private cellular networks, non-terrestrial networks, ambient internet of things (IoT) networks, internet protocol (IP) multimedia subsystem (IMS) networks, private/public/hybrid cloud computing technologies, cloud (off-premise) applications, on-premise applications, vehicle to everything (V2X) networks, and others.

In some examples, scanners according to this disclosure can function independently, and can report network vulnerability information back to a centralized platform. The centralized platform can optionally leverage machine learning or artificial intelligence (ML/AI) to apply advanced behavioral analytics and identify security anomalies. In additional examples, scanners can work collaboratively to identify and correlate events, optionally before reporting vulnerability information back to the centralized platform.

Scanners can optionally be deployed in multiple network locations, or at locations of predetermined location types. Example network location types at which scanners can be deployed include street level locations, in-building locations, mobile switching facility locations, data center locations, vehicle-based locations, etc. Scanners can be deployed at locations with a highest assessed opportunity to discover network vulnerabilities.

Furthermore, scanners can optionally be configured to perform one or more remediation operations to address identified network vulnerabilities. For example, scanners can initiate application programming interface (API) calls into a network to automatically remediate identified gaps, holes, etc. Remediate operations can optionally include, but need not be limited to, disconnecting one or more subscriber devices from a network.

The techniques discussed herein may be implemented in a computer network using one or more of protocols including but are not limited to Ethernet, 3G, 4G, 4G/LTE, 5G, 6G, the further radio access technologies, or any combination thereof. In some examples, the network implementations may support standalone architectures, non-standalone architectures, dual connectivity, carrier aggregation, etc. Example implementations are provided below with reference to the following figures.

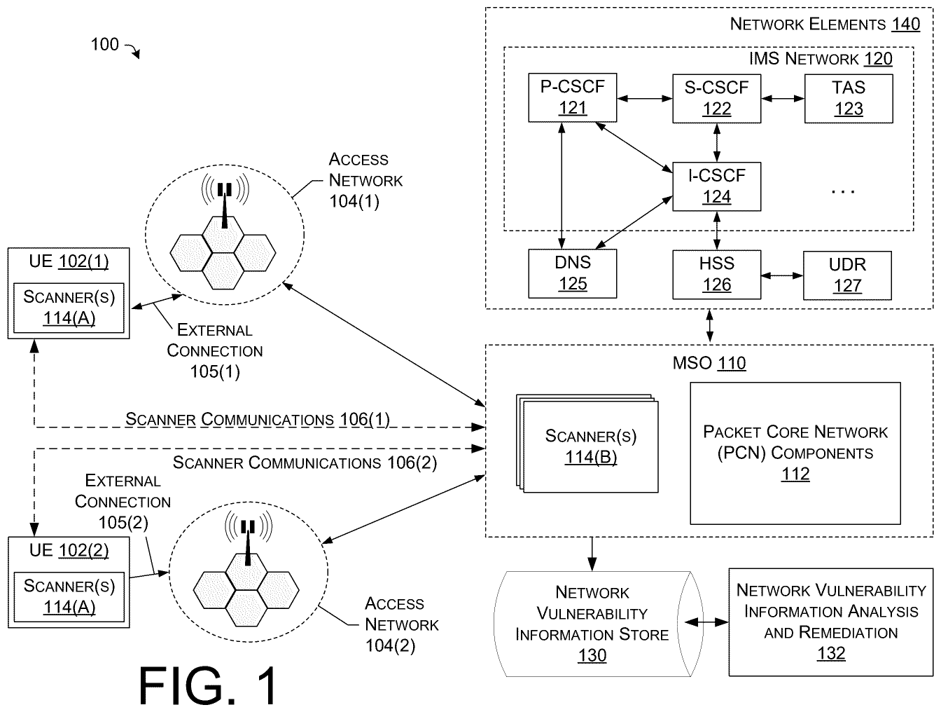

FIG. 1 illustrates an example network architecture 100 including scanner(s) 114(A) deployed at user equipment (UEs) 102(1) and 102(2) and scanner(s) 114(B) deployed at mobile switching office (MSO) 110 equipment, wherein the scanner(s) 114(A) and 114(B) can be configured to perform network vulnerability tests, according to an example of the present disclosure. The example network architecture 100 includes the UEs 120(1), 102(2), access networks 104(1) and 104(2), the MSO 110, a network vulnerability information store 130, network vulnerability information analysis and remediation 132, and additional network elements 140 including an IMS network 120 and various other elements.

UE 102(1) is illustrated as interacting with access network 104(1) via an external connection 105(1), and UE 102(2) is illustrated as interacting with access network 104(2) via an external connection 105(2). Both of the access networks 104(1), 104(2) can in turn interact with the MSO 110. The MSO 110 can in turn interact with the IMS network 120.

An external connection is defined herein as a connection to a network that is that is on an opposite side of access network components, from the perspective of core network components such as the packet core network (PCN) components 112. Thus, for example, the PCN components 112 communicate with the UE 102(1) via access network 104(1). UE 102(1) is therefore on an opposite side of the access network 104(1) as the PCN components 112, and so the UE 102(1) connection to the access network 104(1) is an external connection 105(1). Similarly, the PCN components 112 communicate with the UE 102(2) via access network 104(2). UE 102(2) is therefore on an opposite side of the access network 104(2) as the PCN components 112, and so the UE 102(2) connection to the access network 104(2) is an external connection 105(2).

Connections considered herein to be external connections include connections defined by the third generation partnership project (3GPP) as access stratum type connections which are internal to a mobile network operator. Connections considered herein to be external connections can further include external connections under the 3GPP, such as connections to a 5G security edge protection proxy (SEPP), N32 interface connections for roaming, user plane function (UPF) connections via N6/N9 interfaces for roaming and general Internet access, network exposure function (NEF) for third party integrations, etc.

The UEs 102(1) and 102(2) are illustrated as comprising scanner(s) 114(A), and the MSO 110 is illustrated as comprising the scanner(s) 114B and PCN components 112. Embodiments of this disclosure can include the scanner(s) 114(A), the scanner(s) 114(B), or both. Furthermore, the MSO 110 can also comprise additional components beyond those illustrated in FIG. 1. In some embodiments, the network architecture 100 can include multiple MSOs, each of which may serve multiple access networks and user equipment, just as the MSO 110 serves multiple access networks 104(1) and 104(2) and the UEs 120(1), 102(2). Each of the multiple MSOs can be equipped with scanner(s), similar to MSO 110.

The scanner(s) 114(A) and 114(B) can optionally include multiple different scanners, e.g., different scanners for different UE device types, different scanners for different UE connection types (whether 3G, 4G, 5G, Wi-Fi, etc.), and optionally different scanners for identification of different network vulnerabilities. For scanner(s) 114(A) deployed at UEs 102(1) and 102(2), the MSO 110 can optionally connect to a UE and can be configured to send and receive scanner communications with the UE. Thus, the MSO 110 can communicate with UE 102(1) and its scanner(s) 114(A) via scanner communications 106(1), and the MSO 110 can communicate with UE 102(2) and its scanner(s) 114(A) via scanner communications 106(2).

In some examples, the scanner(s) 114(A) and 114(B) can operate autonomously or semi-autonomously to perform network vulnerability tests and can report resulting information to the MSO 110 and/or to the network vulnerability information store 130. In further examples, the MSO 110 can optionally be configured to use scanner communications 106(1), 106(2) to cause the scanner(s) 114(A) at the UEs 102(1), 102(2) to perform network vulnerability test operations. In this manner, the scanner(s) 114(A) can determine network vulnerabilities which are exposed to the UEs 102(1), 102(2). The UEs 102(1), 102(2) can be configured to report any discovered network vulnerability information back to the MSO 110, and the MSO 110 can be configured to report network vulnerability information to the network vulnerability information store 130 for network vulnerability information aggregation and analysis by the network vulnerability information analysis and remediation 132. In some embodiments, the MSO 110 can also be configured to use scanner communications 106(1), 106(2) and/or other operations to perform autonomous remediation operations to address network vulnerabilities discovered by the scanner(s) 114(A).

A network architecture 100 such as illustrated in FIG. 1 may be part of a telecommunication network of a wireless service provider such as, T-Mobile, AT&T, Verizon Wireless, etc. The telecommunication network may include one or more packet core networks, one or more IP multimedia subsystems (IMSs) and one or more access networks through which, user equipment can connect to the one or more packet core networks and the IMSs. The packet core network, for example, PCN components 112, may be a 4G evolved packet core (EPC) network or a 5G core network. The one or more access networks, for example, access network 104(1) and access network 104(2), may be compatible with one or more radio access technologies, protocols, and/or standards, such as 5G NR technology, LTE/LTE Advanced technology, other Fourth Generation (4G) technology, High-Speed Data Packet Access (HSDPA)/Evolved High-Speed Packet Access (HSPA+) technology, Universal Mobile Telecommunication System (UMTS) technology, Code Division Multiple Access (CDMA) technology, Global System for Mobile Communications (GSM) technology, WiMAX technology, Wi-Fi technology, and/or any other previous or future generation of radio access technology.

The access networks 104(1) and 104(2) may include various types of base stations, for example, 2G base stations and/or 3G NodeBs that are associated with GSM and CDMA access network, eNBs that are associated with an LTE access network known as an Evolved UMTS Terrestrial Radio Access Network (E-UTRAN), or gNBs or as new radio (NR) base stations that are associated with a 5G access network.

The IMS network, for example, IMS network 120, may include multiple components that function together to deliver multimedia communications services such as voice, video and text messaging over the IP network, e.g., PCN components 112. For example, the IMS network 120 may include, inter alia, a proxy call session control function (P-CSCF) 121, an interrogating call session control function (I-CSCF) 124, a serving call session control function (S-CSCF) 122, and a telephony application server (TAS) 123. The IMS network 120 can optionally operate in conjunction with further network elements such as a home subscriber server (HSS) 126, a domain name server (DNS) 125, and a user data request function (UDR) 127.

A user equipment may need to be registered on the IMS network 120 in order to use the IP multimedia service. As shown in FIG. 1, the UE 102(1) may connect to the PCN components 112 through the access network 104(1) and further register on the IMS network 120; while the UE 102(2) may connect to the PCN components 112 through the access network 104(2) and further register on the IMS network 120. During the registration process, the I-CSCF 124 may send a user authentication request (UAR) to the home subscriber server (HSS) 126 to authenticate a user equipment, e.g., UE 102(1) or UE 102(2). The HSS 126 may return a user authentication answer (UAA) that indicates whether the UAR is approved. In some examples, the P-CSCF 121 may query a domain name server (DNS) 125 to discover a fully qualified domain name (FQDN) or the IP address of the I-CSCF 124 to forward the registration request from the UE. The I-CSCF 124 may also query the DNS 125 to obtain the FQDN or the IP address of the S-CSCF 122 to forward the registration request to complete the registration of the UE.

Once the UE 102(1) or UE 102(2) is registered on the IMS network 120, the UE 102(1) or UE 102(2) can use the services provided through a plurality of application servers on the IMS network 120. The TAS 123 in the IMS network 120, for example, may provide basic call processing services and supplementary multimedia services between the users such as call setup, call waiting, call forwarding, caller ID service, origination-denial, termination-denial, lettering and coloring, etc.

It should be understood that the network scenario shown in FIG. 1 is for the purpose of illustration. In various real-world scenarios, telecommunication networks or one or more subsystems of a telecommunication network can be logically divided into a number of regions. Each of the regions may logically include a packet core network and an IMS network. Furthermore, in some examples, each of the DNS 125, the HSS 126, and the TAS 123 may be configured as a centralized component of the telecommunication network accessible to all logically divided IMS networks. Further, although the IMS network as shown in FIG. 1 includes a single P-CSCF 121, a single S-CSCF 122, and a single I-CSCF 124, the IMS network 120 can optionally include two or more P-CSCFs, S-CSCFs, and I-CSCFs.

The techniques discussed herein may be implemented in the telecommunication network using one or more of protocols including but are not limited to Ethernet, 3G, 4G, 4G LTE, 5G, or any combination thereof. The techniques may also optionally be implemented in the telecommunication network using 6G and/or future radio access technologies.

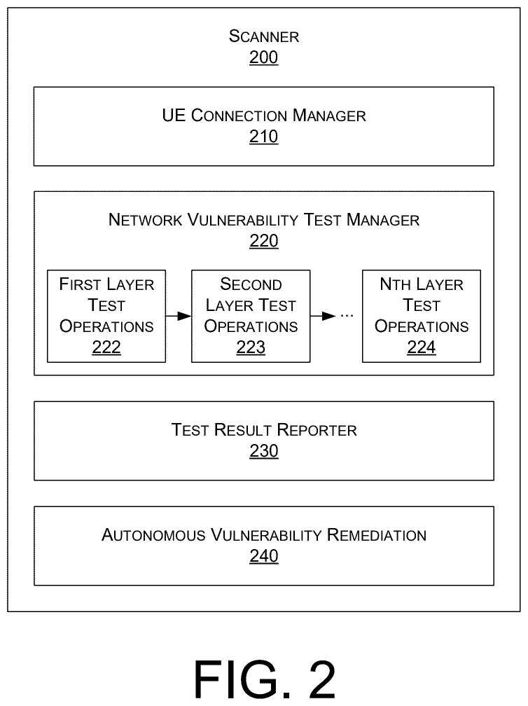

FIG. 2 illustrates an example scanner 200 and components thereof, according to an example of the present disclosure. The scanner 200 can implement one of the scanner(s) 114(A) and/or 114(B) introduced in FIG. 1 in some embodiments. The scanner 200 can include a connection manager 210, a network vulnerability test manager 220, a test result reporter 230, and autonomous vulnerability remediation 240. In an example, the network vulnerability test manager 220 can include first layer test operations 222, second layer test operations 223, . . . , and Nth layer test operations 224.

In example operations of the scanner 200, the scanner 200 can use connection manager 210 to connect to an entity that drives or controls the scanner 200. The scanner 200 can be deployed at a UE 102(1) located in a cellular network region of a cellular network, e.g., the region served by the MSO 110, or the scanner 200 may be deployed among a group of network components, e.g., the PCN components 112 and/or the components of the IMS network 120, in the cellular network region. The scanner 200 can optionally be configured to scan the PCN components 112, the IMS network 120, or components of the access networks 104(1), 104(2). The UE 102(1) may be configured to access the cellular network via an external connection 105(1) to the group of core network components (e.g., the PCN components 112) in the cellular network region.

In an example, the scanner 200 can be configured for deployment at UEs of a particular device type, such as a particular make and model of mobile device, or the scanner 200 can be configured for deployment at UEs of multiple different device types. The scanner 200 can furthermore be configured perform network vulnerability tests which may comprise test operations that are customized for the UE device type(s).

Similarly, the scanner 200 can be configured to for deployment at UEs which have particular connection types, such as a 4G, 5G, or other connection types, or the scanner 200 can be configured for deployment at UEs with external connections of multiple different connection types. The scanner 200 can furthermore be configured perform network vulnerability tests which may comprise test operations that are customized for the connection type(s).

Once the scanner 200 has established a connection, e.g., to the MSO 100 via the connection manager 210, the scanner 200 can employ the network vulnerability test manager 220 to perform one or more network vulnerability tests. The network vulnerability tests can comprise network operations of UE 102(1) under direction of the scanner 200. By directing the UE 102(1) to perform operations and collecting resulting vulnerability information, the scanner 200 acquires a view of network vulnerabilities from the perspective of the UE 102(1). In some examples, the MSO 110 can use scanner communications 106(1) to cause the UE 102(1) to perform network vulnerability test operations to determine network vulnerability information associated with the external connection 105(1) to the group of core network components implemented by PCN components 112.

Network vulnerability tests performed under direction of the network vulnerability test manager 220 can comprise any tests and this disclosure is not limited to any particular test operations. Many tests can involve sending communications by the UE 102(1), receiving responsive communications at the UE 102(1), and determining whether the responsive communications include or otherwise expose any information about the identity or configuration of the PCN components 112. In an example, network vulnerability information exposed by network vulnerability tests can comprise information indicative of an existence of an individual core network component among the PCN components 112 or for example among the IMS network 120. Information indicative of existence of the core network component can include, e.g., identification or configuration information associated with the core network component. In another example, network vulnerability information exposed by network vulnerability tests can comprise information indicative of a misconfiguration of an individual core network component among a group of core network components such as the PCN components 112.

Some example network vulnerability test operations can comprise performing multiple send operations, by the UE 102(1) under direction of the scanner 200, to send first information via the cellular network to which the UE 102(1) is connected. The cellular network returns second information in response to the multiple send operations, which can be received at the UE 102(1). The scanner 200 can then scan the second information for a pattern to determine network vulnerability information. Certain patterns can be indicative of information or configuration of the PCN components 112, which is exposed by the pattern. For example, a timing associated with the second information, or metadata or other data included in the second information, can reveal a pattern.

Some further example network vulnerability test operations can comprise multi-layer operations such as illustrated in FIG. 2. The multi-layer operations can comprise, e.g., first layer test operations 222, second layer test operations 223, . . . , Nth layer test operations 224. The first layer test operations 222 can comprise, e.g., a first vulnerability test operation to determine at least one first vulnerability. The second layer test operations 223 can comprise, e.g., a second vulnerability test operation to determine at least one second vulnerability. The Nth layer test operations 224 can comprise, e.g., a Nth vulnerability test operation to determine at least one Nth vulnerability. The second and any subsequent vulnerabilities may be related to the first vulnerability and performance of the second and subsequent vulnerability test operations may be contingent on a result of the first or other previous vulnerability test operations.

In an example of multi-layer operations, first layer test operations 222 may be configured to determine, as a first vulnerability, an exposed internet protocol (IP) address of a core network component among PCN components 112. The second layer test operations 223 can be triggered if such an exposed IP address is discovered. second layer test operations 223 can be configured to determine, as a second vulnerability, whether any ports are accessible which are associated with the exposed IP address.

Regardless of the network vulnerability tests performed under the direction of the network vulnerability test manager 220, network vulnerability information can be received at the UE 102(1) as a result of the network vulnerability tests. The network vulnerability information can include, e.g., data indicative of exposed information pertaining to PCN components 112 which is visible by the UE 102(1). The UE 102(1) can report network vulnerability information to the MSO 110 as part of scanner communications 106(1). The scanner 200 can employ the test result reporter 230 to optionally filter and then report network vulnerability information to the MSO 110, which can in turn report the network vulnerability information to a network vulnerability information store, such as the network vulnerability information store 130 illustrated in FIG. 1.

In some examples, the scanner 200 can furthermore be equipped with autonomous vulnerability remediation 240. Autonomous vulnerability remediation 240 can be activated by the scanner 200 in response to identification, at the scanner and in response to network vulnerability information received from a UE, or one or more network vulnerabilities which the autonomous vulnerability remediation 240 is equipped to remediate. One example remediation operation may include disconnecting a UE from the network, or disconnecting a group of UEs which are identifiable as having access to an exposed vulnerability. Another example remediation operation may include disabling an IP address or port address of one or more components among PCN components 112.

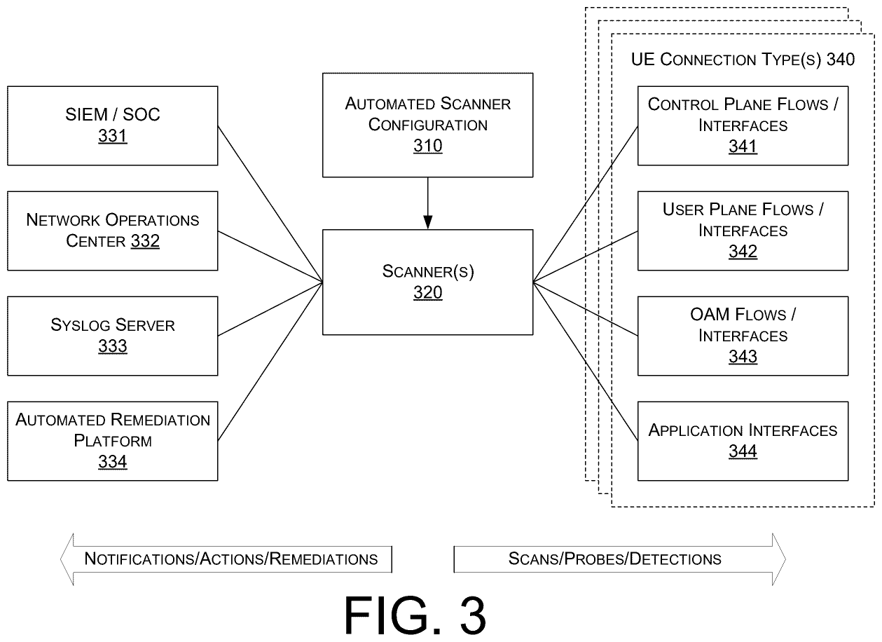

FIG. 3 illustrates example configuration and operation of scanner(s) 320, according to another example of the present disclosure. FIG. 3 comprises automated scanner configuration 310, scanner(s) 320, example notifications/actions/remediations that can be performed by the scanner(s) 320, and example scans/probes/detections that can be performed by the scanner(s) 320.

Automated scanner configuration 310 can optionally configure scanners 320 to perform network vulnerability tests adapted for different UEs, including different network connection types, and different network infrastructure. Automated scanner configuration 310 can be run once, resulting in scanner(s) 320, or automated scanner configuration 310 can be run repeatedly to continuously update existing scanner variations as new threats are identified, new types of UEs are supported, new UE network connection types are supported, new/updated network infrastructure is deployed, etc.

The example notifications/actions/remediations that can be performed by the scanner(s) 320 include providing notifications to trigger a security response at block 331, e.g., by tools such as security information and event management (SIEM) and/or personnel in a security operations center (SOC). A notification to trigger a network operations center response can be generated at block 332. A notification to a syslog server can be generated at block 333. A notification to trigger an automated remediation platform response can be generated at block 334.

The example scans/probes/detections that can be performed by the scanner(s) 320 can include different types of network vulnerability tests which are adapted for each of multiple different UE connection types 340. The UE connection types 340 can include, e.g., cellular, Wi-Fi, citizens broadband radio service (CBRS), Bluetooth, Zigbee, wired, and NFC. The scanner(s) 320 can perform different types of network vulnerability tests which are adapted to the network infrastructure including the PCN, IMS, RAN, transport, etc.

Network vulnerability tests that can be performed for each of the UE connection types 340 include tests of control plan flows/interfaces 341, tests of user plane flows/interfaces 342, tests of operations and management (OAM) flows/interfaces 343, and tests of application interfaces 344.

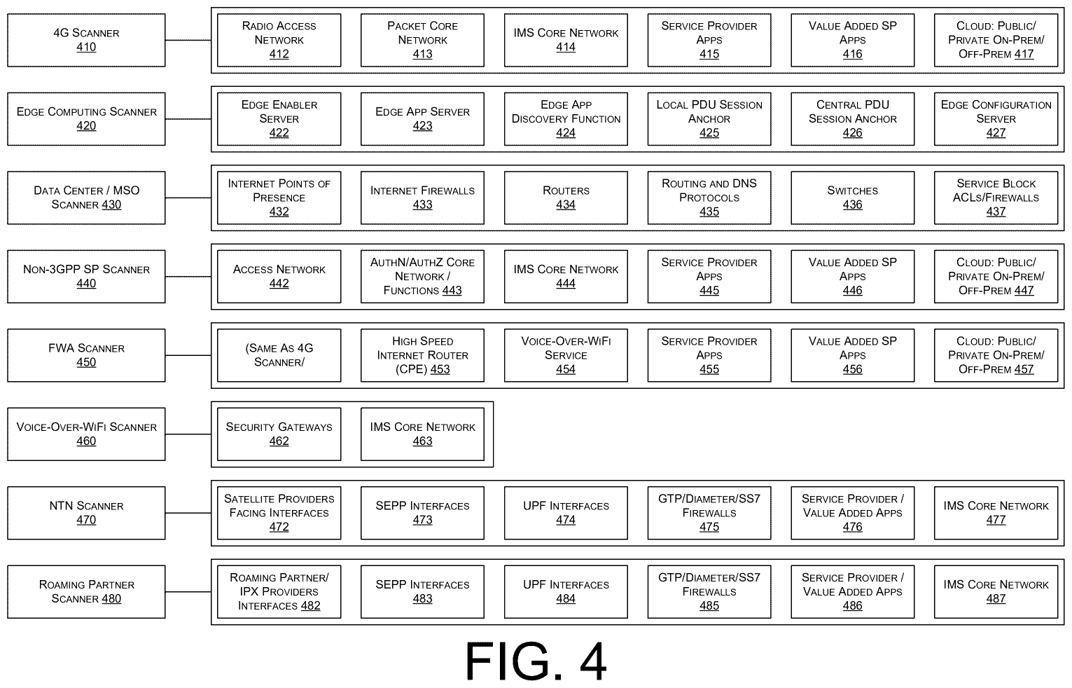

FIG. 4 illustrates a variety of example scanners and example network components which can be scanned thereby, according to an example of the present disclosure. FIG. 4 is not intended to be exhaustive. Instead, FIG. 4 provides a general outline of potential scanner types and corresponding example networks and network components which may be scanned thereby.

A 4G scanner 410 can perform network vulnerability tests to evaluate vulnerabilities of a radio access network 412, a packet core network 413, an IMS core network 414, service provider apps 415, value added service provider (SP) apps 416, and/or a cloud: public/private, on-prem or off-prem 417. Additional scanners can include scanners adapted for use in connection with 2G, 3G, 4G, 5G, 6G, etc.

An edge computing scanner 420 can perform network vulnerability tests to evaluate vulnerabilities of an edge enabler server 422, an edge app server 423, an edge app discovery function 424, a local PDU session anchor 425, a central PDU session anchor 426, and/or an edge configuration server 427.

A data center/MSO scanner 430 can perform network vulnerability tests to evaluate vulnerabilities of internet points of presence 432, internet firewalls 433, routers 434, routing and DNS protocols 435, switches 436, and/or service block ACLs/firewalls 437.

A non-third generation partnership project (3GPP) service provider (SP) scanner 440 can perform network vulnerability tests to evaluate vulnerabilities of an access network 442, an Authentication/Authorization core network and functions 443, an IMS core network 444, service provider apps 445, value added service provider (SP) apps 446, and/or a cloud: public/private, on-prem or off-prem 447.

A fixed wireless access (FWA) scanner 450 can perform network vulnerability tests to evaluate vulnerabilities of same or similar targets as the 4G scanner 410. In addition, the FWA scanner 450 can perform network vulnerability tests of a high speed internet router (e.g., customer premise equipment (CPE)) 453, a voice-over-Wi-Fi service 454, service provider apps 455, value added service provider (SP) apps 456, and/or a cloud: public/private, on-prem or off-prem 457.

A voice-over-Wi-Fi scanner 460 can perform network vulnerability tests to evaluate vulnerabilities of security gateways 462 and/or an IMS core network 463.

A non-terrestrial network (NTN) scanner 470 can perform network vulnerability tests to evaluate vulnerabilities of satellite providers' facing interfaces 472, security edge protection proxy (SEPP) interfaces 453, user plane function (UPF) interfaces 474, GTP/Diameter/SS7 (Signaling System 7) firewalls 475, service provider/value added apps 476, and/or an IMS core network 477.

A roaming partner scanner 480 can perform network vulnerability tests to evaluate vulnerabilities of roaming partner/IPX (IP Exchange) providers' interfaces 482, (SEPP) interfaces 483, UPF interfaces 484, GTP/Diameter/SS7 firewalls 485, service provider/value added apps 486, and/or an IMS core network 487.

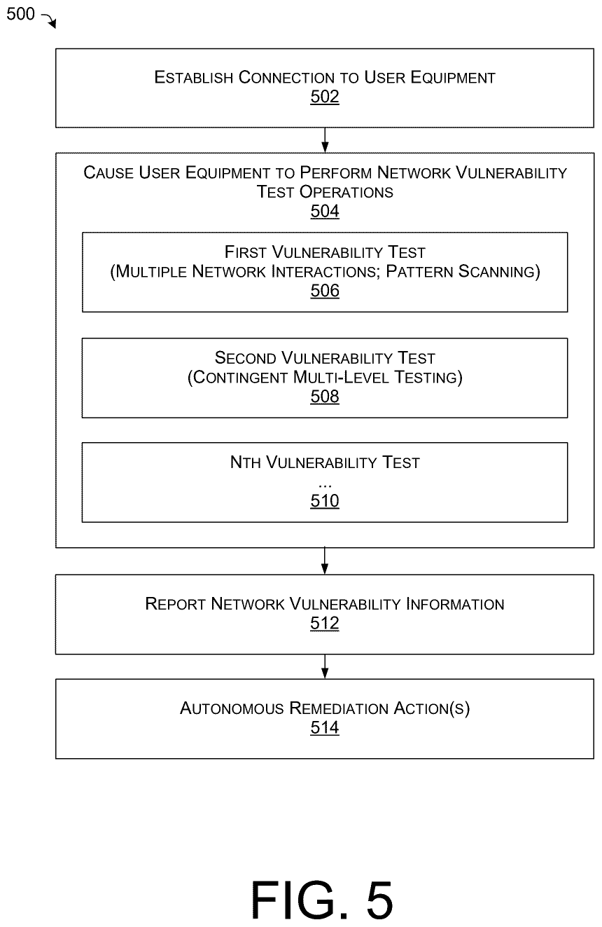

FIG. 5 is a flowchart illustrating example operations performed by a scanner, according to an example of the present disclosure. By way of example and without limitation, the processes are illustrated as logical flow graphs, each operation of which represents a sequence of operations of a computer-implemented method that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined (or omitted) in any order and/or in parallel to implement the processes. In some examples, multiple branches represent alternate implementations that may be used separately or in combination with other operations discussed herein.

The operations illustrated in FIG. 5 can be performed at least in part by network equipment equipped with one or more scanners, such as the UEs 102(1) or 102(2) equipped with scanners 114A, or the MSO 110 equipped with scanners 114B as illustrated in FIG. 1. At operation 502, an MSO 110 can establish a connection to user equipment, e.g., to the UE 102(1). The UE 102(1) can be located in a cellular network region of a cellular network, and the MSO 110 can comprise a group of core network components in the cellular network region, for example, the MSO 110 can comprise the PCN components 112 and the MSO 110 can serve the region of the access network 104(1). The UE 102(1) can be configured to access the cellular network via an external connection 105(1) to the group of core network components (the PCN components 112) in the cellular network region of the access network 104(1).

Depending on scanner configuration, the scanner may be configured to connect to a UE 102(1), or to multiple UEs of a same type, or to multiple UEs of multiple different types. Similarly, the scanner may be configured to connect to UE's associated with external connections of one type, or the scanner may be configured to connect to UE's associated with external connections of multiple different types. Furthermore, scanners can be configured to be deployed among network infrastructure, such as the PCN components 112, and the scanners can be configured to connect to or scan any network infrastructure components.

At operation 504, the scanner can cause the UE 102(1) in the cellular network region, or the MSO 110 to perform network vulnerability test operations to determine network vulnerability information associated with the external connection 105(1) to the group of core network components (the PCN components 112) in the cellular network region. The vulnerability test operations can perform one or more tests, e.g., a first vulnerability test 506, a second vulnerability test 508, and/or further vulnerability tests up to an Nth vulnerability test 510.

The first vulnerability test 506 can comprise, for example, multiple network interactions including multiple send operations to send first information via the cellular network, wherein the cellular network returns second information in response to the multiple send operations. The second information can be scanned for a pattern to determine the network vulnerability information. Some patterns can expose network vulnerabilities while others may not.

The second vulnerability test 508 can comprise, for example, contingent multi-level testing comprising, e.g., a first vulnerability test operation to determine at least one first vulnerability, and a second vulnerability test operation to determine at least one second vulnerability, wherein the second vulnerability is related to the first vulnerability and wherein the second vulnerability test operation is contingent on a result of the first vulnerability test operation.

Vulnerability tests at operation 504 can be used to assess whether network vulnerability information can be discovered, wherein the network vulnerability information may be, e.g., indicative of an existence of an individual core network component among the group of core network components in PCN components 112. Alternatively, the network vulnerability information may comprise, e.g., information indicative of a misconfiguration of an individual core network component among the group of core network components in PCN components 112.

At operation 512, the scanner can report network vulnerability information to a network vulnerability information store 130 for the cellular network. The network vulnerability information store 130 can comprise information collected from multiple scanners, optionally in multiple different regions/MSOs, and can optionally be analyzed by network vulnerability information analysis and remediation 132, which can include machine learning (ML)/artificial intelligence (AI) processes to identify and address network vulnerabilities.

At operation 514, the scanner can optionally perform one or more autonomous remediation actions in response to the network vulnerability information from the UE 102(1) or network infrastructure. An example remediation action may be reporting an event to a security system, disconnecting the UE 102(1) from the access network 104(1), or any other action to prevent or discourage network compromise. Further example remediation actions may comprise reporting an event to a security system, spinning down a vulnerable or compromised virtual compute instance in the network infrastructure, spinning up a new clean virtual compute instance, and redirecting the relevant network traffic to the new clean virtual compute instance.

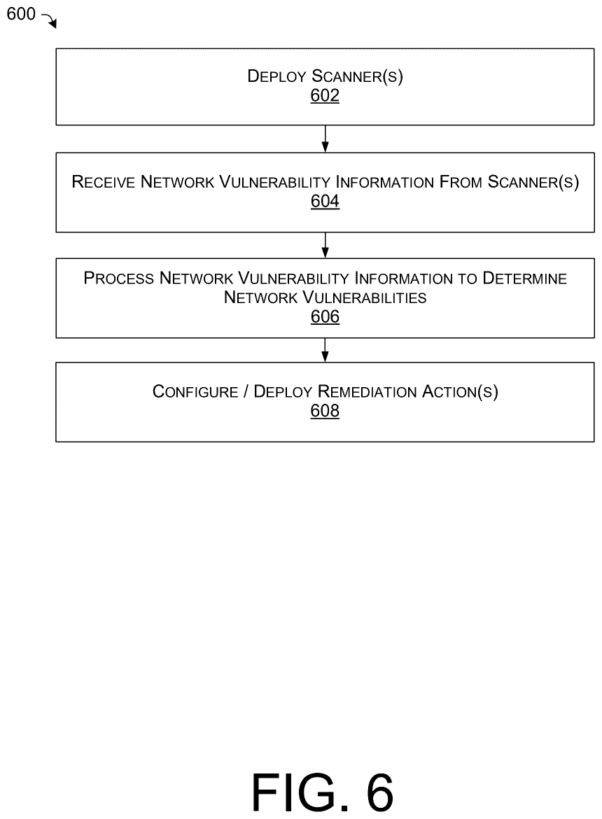

FIG. 6 is a flowchart illustrating example operations performed by network equipment configured to deploy and use scanners to determine network vulnerabilities, according to an example of the present disclosure. By way of example and without limitation, the processes are illustrated as logical flow graphs, each operation of which represents a sequence of operations of a computer-implemented method that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined (or omitted) in any order and/or in parallel to implement the processes. In some examples, multiple branches represent alternate implementations that may be used separately or in combination with other operations discussed herein.

The operations illustrated in FIG. 6 can be performed at least in part by a scanner configuration component such as automated scanner configuration 310 illustrated in FIG. 3. Operation 602 comprises deploying scanner(s). In an example, respective network vulnerability scanners, e.g., the scanner(s) 114(A) and/or 114(B), can be deployed in a cellular network. The cellular network can comprise respective groups of core network components (network infrastructure) in each of multiple respective cellular network regions. For example, different respective MSOs in different regions can comprise different respective network infrastructure components. Respective network vulnerability scanners can be deployed among respective groups of core network components in each of the multiple respective MSOs/cellular network regions.

The respective network vulnerability scanners deployed at operation 602 can be configured as described herein, namely, to connect to respective user equipment in the multiple respective cellular network regions, e.g., regions associated with different MSOs. The respective user equipment can be configured to access the cellular network via respective external connections to respective groups of core network components in each of the multiple respective cellular network regions. Furthermore, the respective user equipment may comprise multiple user equipment of multiple different types, and the respective external connections may comprise multiple external connections of multiple different types.

Furthermore, the respective network vulnerability scanners deployed at operation 602 can be configured to cause the respective user equipment in the multiple respective cellular network regions to perform respective network vulnerability test operations to determine network vulnerability information associated with the respective external connections to the respective groups of core network components in each of the multiple respective cellular network regions. In an example, the network vulnerability information can comprise, e.g., information indicative of an existence of an individual core network component among the respective groups of core network components, such as an identity or configuration information associated with of one of the PCN components 112. In another example, the network vulnerability information can comprise, e.g., information indicative of a misconfiguration of an individual core network component among the respective groups of core network components, such as a misconfiguration of one of the PCN components 112.

Respective network vulnerability test operations performed by scanners deployed at operation 602 can comprise any network vulnerability tests. An example network vulnerability test can include a first vulnerability test operation to determine at least one first vulnerability, and a second vulnerability test operation to determine at least one second vulnerability. The second vulnerability can be related to the first vulnerability and the second vulnerability test operation can be contingent on a result of the first vulnerability test operation. For example, the at least one first vulnerability comprises an exposed internet protocol (IP) address, and the at least one second vulnerability comprises a port associated with the exposed IP address.

Another example network vulnerability test can include causing a user equipment to perform multiple send operations to send first information via the cellular network, wherein the cellular network returns second information in response to the multiple send operations. The second information can then be scanned for a pattern to determine the network vulnerability information.

Operation 604 comprises receiving the network vulnerability information from the respective network vulnerability scanners, e.g., from either of the scanners 114(A) or the scanners 114(B) and storing the network vulnerability information in a network vulnerability information store for the cellular network, such as the network vulnerability information store 130.

At operation 606, the network vulnerability information in the network vulnerability information store 130 can be processed, e.g., by network vulnerability information analysis and remediation 132, in order to determine at least one network vulnerability associated with the cellular network. Machine learning and artificial intelligence techniques can optionally be applied to process information in the network vulnerability information store 130.

Operation 608 comprises performing a remediation action in response to the network vulnerability information. Operation 608 stands in contrast to autonomous remediation performed by scanner(s) 114(A) and 114(B), in that operation 608 can be performed for example by network vulnerability information analysis and remediation 132. Operation 608 can be based on analysis of network vulnerability information from multiple scanners deployed across the network and so can optionally address different and potentially wider network vulnerabilities involving multiple MSOs, cellular regions, and PCNs. Remediation actions at operation 608 can include, e.g., reconfiguring a PCN component of PCNs at multiple MSOs, or reconfiguring IMS network components of multiple IIMS networks.

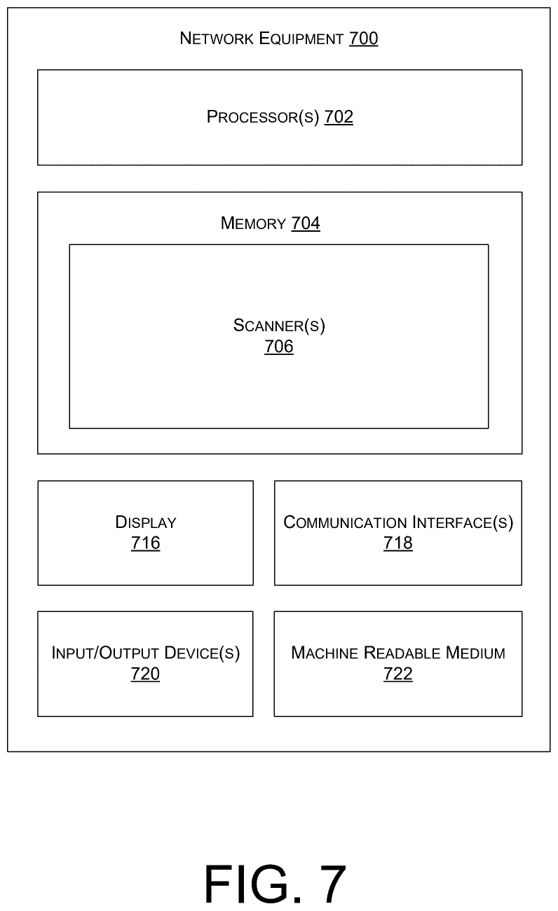

FIG. 7 illustrates example network equipment that can implement the techniques disclosed herein, according to an example of the present disclosure. In some embodiments, the example network equipment 700 may correspond to an element of an MSO, such as the MSO 110 illustrated in FIG. 1. In other embodiments, the example network equipment 700 may correspond to an operator provisioning server, such as a server that comprises the automated scanner configuration 310 illustrated in FIG. 3.

As illustrated in FIG. 7, a network equipment 700 may comprise processor(s) 702, a memory 704 storing scanner(s) 706, a display 716, communication interface(s) 718, input/output device(s) 720, and/or a machine readable medium 722.

In various examples, the processor(s) 702 can be a central processing unit (CPU), a graphics processing unit (GPU), or both CPU and GPU, or any other type of processing unit. Each of the one or more processor(s) 702 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 702 may also be responsible for executing all computer applications stored in memory 704, which can be associated with common types of volatile (RAM) and/or nonvolatile (ROM) memory.

In various examples, the memory 704 can include system memory, which may be volatile (such as RAM), non-volatile (such as ROM, flash memory, etc.) or some combination of the two. The memory 704 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the network equipment 700. Any such non-transitory computer-readable media may be part of the network equipment 700.

In embodiments wherein the network equipment 700 implements an element of an MSO, such as the MSO 110 illustrated in FIG. 1, the scanner(s) 706 can be configured as scanners 114(B) to perform offense-type scanning for network vulnerabilities as described herein. In embodiments wherein the network equipment 700 implements a UE, such as the UE 102(1) or the UE 102(2) illustrated in FIG. 1, the scanner(s) 706 can be configured as scanners 114(A) to perform offense-type scanning for network vulnerabilities as described herein.

The communication interface(s) 718 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 718 can be compatible with multiple radio access technologies, such as 5G radio access technologies, 4G/LTE radio access technologies, and any other future defined radio access technologies. Accordingly, the communication interfaces 718 can allow the network equipment 700 to connect to the 5G system described herein.

Display 716 can be a liquid crystal display or any other type of display commonly used in the network equipment 700. For example, display 716 may be a touch-sensitive display screen and can then also act as an input device or keypad, such as for providing a soft-key keyboard, navigation buttons, or any other type of input.

Input/output device(s) 720 can include any sort of output devices known in the art, such as a display, speakers, a vibrating mechanism, and/or a tactile feedback mechanism. Input/output device(s) 720 can also include ports for one or more peripheral devices, such as headphones, peripheral speakers, and/or a peripheral display. Input/output device(s) 720 can include any sort of input devices known in the art. For example, input/output device(s) 720 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 722 can store one or more sets of instructions, such as software or firmware, which embodies any one or more of the methodologies or functions described herein. The instructions can also reside, completely or at least partially, within the memory 704, processor(s) 702, and/or communication interface(s) 718 during execution thereof by the network equipment 700. The memory 704 and the processor(s) 702 also can constitute machine readable media 722.

The various techniques described herein may be implemented in the context of computer-executable instructions or software, such as program modules, which are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, are not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computer-implemented method comprising:
deploying a network vulnerability scanner to user equipment in a cellular network, wherein the network vulnerability scanner is configured to scan for a network vulnerability associated with at least one core network component in a group of core network components, and wherein the user equipment is configured to access the cellular network via an external connection to the group of core network components in the cellular network;
causing, by the network vulnerability scanner, the user equipment in the cellular network region to perform network vulnerability test operations to determine network vulnerability information associated with the at least one core network component in the group of core network components in the cellular network; and
reporting, by the network vulnerability scanner, the network vulnerability information to a network vulnerability information store for the cellular network.

2. The computer-implemented method of claim 1, wherein the network vulnerability test operations comprise a first vulnerability test operation to determine at least one first vulnerability, and a second vulnerability test operation to determine at least one second vulnerability, wherein the second vulnerability is related to the first vulnerability and wherein the second vulnerability test operation is contingent on a result of the first vulnerability test operation.

3. The computer-implemented method of claim 1, wherein the network vulnerability test operations comprise:
performing multiple send operations to send first information via the cellular network, wherein the cellular network returns second information in response to the multiple send operations; and
scanning the second information for a pattern to determine the network vulnerability information.

4. The computer-implemented method of claim 1, wherein the user equipment comprises multiple user equipment of multiple different types.

5. The computer-implemented method of claim 1, wherein the external connection comprises multiple external connections of multiple different types.

6. The computer-implemented method of claim 1, wherein the network vulnerability information comprises information indicative of identification or configuration information of an individual core network component among the group of core network components.

7. The computer-implemented method of claim 1, wherein the network vulnerability information comprises information indicative of a misconfiguration of an individual core network component among the group of core network components.

8. The computer-implemented method of claim 1, further comprising performing an autonomous remediation action by the network vulnerability scanner in response to the network vulnerability information.

9. A system comprising:
a processor,
a network interface, and
non-transitory memory storing instructions executed by the processor to perform actions including:
deploying respective network vulnerability scanners in a cellular network, wherein the cellular network comprises respective groups of core network components in each of multiple respective cellular network regions;
wherein the respective network vulnerability scanners are configured to cause respective user equipment in the multiple respective cellular network regions to perform respective network vulnerability test operations to determine network vulnerability information associated with respective user equipment connections to the respective groups of core network components in each of the multiple respective cellular network regions; and
receiving the network vulnerability information from the respective network vulnerability scanners and storing the network vulnerability information in a network vulnerability information store for the cellular network.

10. The system of claim 9, further comprising processing the network vulnerability information in the network vulnerability information store in order to determine at least one network vulnerability associated with the cellular network.

11. The system of claim 10, further comprising performing a remediation action in response to the network vulnerability information.

12. The system of claim 9, wherein the respective network vulnerability test operations comprise a first vulnerability test operation to determine at least one first vulnerability, and a second vulnerability test operation to determine at least one second vulnerability, wherein the second vulnerability is related to the first vulnerability and wherein the second vulnerability test operation is contingent on a result of the first vulnerability test operation.

13. The system of claim 12, wherein the at least one first vulnerability comprises an exposed internet protocol (IP) address, and wherein the at least one second vulnerability comprises a port associated with the exposed IP address.

14. The system of claim 9, wherein the respective network vulnerability test operations comprise:
performing multiple send operations to send first information via the cellular network, wherein the cellular network returns second information in response to the multiple send operations; and
scanning the second information for a pattern to determine the network vulnerability information.

15. The system of claim 9, wherein the respective user equipment comprises multiple user equipment of multiple different types, and wherein the respective user equipment connections comprise multiple external connections of multiple different types.

16. The system of claim 9, wherein the network vulnerability information comprises information indicative of an existence of an individual core network component among the respective groups of core network components.

17. The system of claim 9, wherein the network vulnerability information comprises information indicative of a misconfiguration of an individual core network component among the respective groups of core network components.

18. A computer-implemented method comprising:
causing respective network vulnerability scanners deployed at respective user equipment in multiple cellular network regions to perform respective network vulnerability test operations;
wherein the respective user equipment connects to the cellular network via different respective connections to different respective groups of core network components in different respective cellular network regions of the multiple cellular network regions;
determining network vulnerability information based on the respective network vulnerability test operations and associated with the respective groups of core network components; and
storing the network vulnerability information in a network vulnerability information store for the cellular network.

19. The computer-implemented method of claim 18, wherein the respective user equipment comprises user equipment of multiple different types, and wherein the respective connections comprise external connections of multiple different types.

20. The computer-implemented method of claim 18, wherein the network vulnerability information comprises:
information indicative of an existence of an individual core network component among the respective groups of core network components; or
information indicative of a misconfiguration of an individual core network component among the respective groups of core network components.
